(19) United States
(12) Patent Application Publication
(10) Pub. No.: US 2004/0041838 A1
(43) Pub. Date: Mar. 4, 2004

(54) Method and system for graphing data

(76) Inventors: Venkata J.R.B. Adusumilli, Sunnyvale, CA (US); Charles G. Kappell III, Bakersfield, CA (US); David P. Morrison, Sixes, OR (US); Rama Sundaram, Cupertino, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 10/235,085

(22) Filed: Sep. 4, 2002

(51) Int. Cl. G09G 5/00

(52) U.S. Cl. 345/772

(57) ABSTRACT

A method and means for interfacing between an application and a database to facilitate graphical charting of selected data included in the database. The selected data can be representative of a quantitative relationship between two or more sets of values. A programming layer can be generated to receive indications from a user of which data will be charted and create a programming statement to retrieve and chart the indicated data. A chart is graphed according to the retrieved data. In some embodiments, a user can select values to plot from pre-defined groups of data that have been created to organize available data into logical categories meaningful to a user.

### FIELD OF THE INVENTION

The present invention relates to a method and apparatus for charting data retrieved from a database and, more particularly, embodiments of the present invention relate to methods, means, apparatus, and computer program code for receiving user input indicative of a quantitative relationship between two or more sets of values and graphically charting the indicated relationship.

### BACKGROUND OF THE INVENTION

Databases are widely used to store and manipulate data. Computing has entered into a variety of aspects of the business world and into a great many facets of recreational and public functions. As a result, databases often store large amounts of data. This data is often of little use unless it can be easily understood and interpreted by a user. However, the complexity and diversity of data structures can make it difficult for a non-technical user to retrieve, understand and interpret the data.

A user may have knowledge that certain data of interest exists and even be familiar with the general content of a database containing the data of interest, as well as how particular data needs to be presented. Unfortunately, the user often may not be familiar with the structure of the database. The user often is not familiar with the one (or more) programming languages that must be manipulated to satisfactorily retrieve, display and manipulate a graphical presentation of the data of interest.

An example of a business which generates and relies on large amounts of data is a telephone call center. Call center managers and administrators often do not have backgrounds in database design. These managers and administrators or other interested party (generally referred to herein as “users”), however, need to be able to retrieve, manipulate, and display data regarding call center statistics. For example, a user may know that a database includes fields of data relating to individual telephone calls received from customers. The database may include large amounts of data collected by a bank of telephone agents who answer the calls. The telephone agents may capture certain data relating to each call and store the captured data in one or more databases. The user may have a need to generate and display a graphical representation, or other presentation, of some of the data that has been captured. Unfortunately, however, it can be difficult for many users to quickly, accurately, and easily retrieve and present data from complex databases. Further, many applications which are used to store data do not provide the ability to easily create graphical representations of data and require that the data be exported or ported to other applications for this purpose. Unfortunately, this porting of data can be time-consuming, complicated, and prone to errors.

Graphing programs are available which can access an independent database and produce a graphical depiction of data stored therein. Unfortunately, however, the user operating the graphing program must have a working knowledge of any database structures involved. For example, existing graphing programs may require that the user be conversant with one or more database access methods such as, for example: structured query language (SQL); open database connectivity standard (ODBC); data access object (DAO); ActiveX Data Objects (ADO); Remote Data Objects (RDO); or the like. Without detailed familiarity with a particular database access method, it is difficult for a user to retrieve, manipulate, or display data from a database.

A user with a business need may otherwise be well schooled in the use of computers but still be stymied by an inability to access and chart data in a graphed format or in some other desired manner that facilitates the use of raw data.

It would be advantageous therefore to provide a method and apparatus that can overcome the drawbacks of the prior art. In particular, it would be desirable to provide methods, apparatus, means and computer code which facilitate creation of a graph by a user, wherein the user is not required to have a working knowledge a pertinent database structure or access utility, such as SQL, ODBC and the like, or other technical requirements.

### SUMMARY OF THE INVENTION

Accordingly, the present invention provides systems and methods for allowing a user to readily graph statistical or other data contained in an industry standard compliant database such as a SQL database. Viewing a quantitative relationship between two or more sets of values in graphical form is facilitated by receiving a description of a data source independent of a graphing application program and generating a graphical user interface according to a database structure of the data source. Input can be received via the graphical user interface that is indicative of which data included in the data source will be graphed.

One or more statements can be dynamically generated that are suitable for retrieving data from the data source. The statements are responsive to the input received via the graphical user interface. Data is retrieved from the data source via the generated statements generated and a graph can be created based upon the retrieved data.

In some embodiments, the statement that is dynamically generated can include data fields and a location of the data fields, as well as a condition filter for selecting data stored in the data fields. An order can also be specified for data retrieved as a result of the database query. The statement can include, for example, a programmed select statement.

Input received via the graphical user interface can include, for example, an indication of a selection of a data group, a data point and one or more data elements. A data group can include, for example, a permission level which is equal to or less than a permission level of the graphing application program. Each data point and data element can include a permission level that is equal to or less than a permission level of the graphing application program.

Different embodiments can include, for example, a data source that is ODBC compliant, SQL compliant, ActiveX Data Objects compliant, Remote Data Objects compliant or other structure.

In some embodiments, data returned from the data source as a result of the generated statement can be received and converted into internal arrays.

In another aspect, embodiments can include a predefined graph that is loaded with predefined selected data or loaded with data interactively selected by a user. One or more graph parameters can also be received from a user.

Still other embodiments can include determining the identity of a user and selecting, based at least in part on the identity, a plurality of available data groups in an external database. Based on the plurality of available data groups selected, a graphical user interface can be generated which allows the user make various selections, such as, for example, a data group, a data point within the selected data group and at least a first data element associated with the data point, and at least a first criteria item for graphing data. A graphical depiction of the data can be generated based on the user selected data.

A data group can include, for example, a selection of data which can be utilized to define a graph. A data point can include a data field by which query results can be grouped, and a data element can include a statistic field in a view. A criteria item can include an item utilized to limit a query result to a particular set of values.

From a different perspective, embodiments can also include selecting a data group from among a plurality of available data groups and also selecting a data point in the selected data group. At least a first data element can be associated with the data point and at least a first criteria can be identified for graphing the data. Data can be retrieved from an external database based upon the criteria, data element, data point and data group selected and a graph generated depicting the data retrieved. Embodiments can include: the data groups having a common characteristic, such as a set of call center data; a data point that is a data field in said selected data group; a statistic field summarized based on the data point; a value identifying particular characteristics of the first data element; or other characteristic.

Other embodiments of the present invention can include a computerized system, executable software, or a data signal implementing the inventive methods of the present invention.

Various features and embodiments are further described in the following figures, drawings and claims.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 illustrates a block diagram of an exemplary implementation of the present invention;

FIG. 2 illustrates exemplary steps that can be executed by a user while implementing the present invention.

FIG. 3 illustrates steps that can be executed by a computerized device while implementing the present invention.

FIG. 4 illustrates steps that can be implemented by a computerized device to build a SQL statement.

FIG. 5 illustrates a network of computerized devices which can be utilized to implement the present invention.

FIG. 6 illustrates a graphical user interface that can receive an indication of which data will be graphically displayed.

FIG. 7 illustrates a GUI with a toolbar that includes a button to access graphical charting.

FIG. 8 illustrates an exemplary graph that can be generated from data collected from a call center application.

FIG. 9 illustrates an exemplary GUI that can be utilized to facilitate selection of graph parameters.

FIG. 10 illustrates an exemplary GUI with steps that can be performed to generate and view a graph.

FIGS. 11a-11c illustrate a flow of exemplary steps that can be utilized in a call center graphing application.

### DETAILED DESCRIPTION

The present invention includes methods and apparatus for interfacing between an application and a database to facilitate graphical charting of the data representative of a quantitative relationship between two or more sets of values. A programming layer can be generated to receive indications from a user of which data will be charted and create a programming statement to retrieve and chart the indicated data. In some embodiments, a user can select values to plot from pre-defined groups of data that have been created to organize available data into logical categories meaningful to a user.

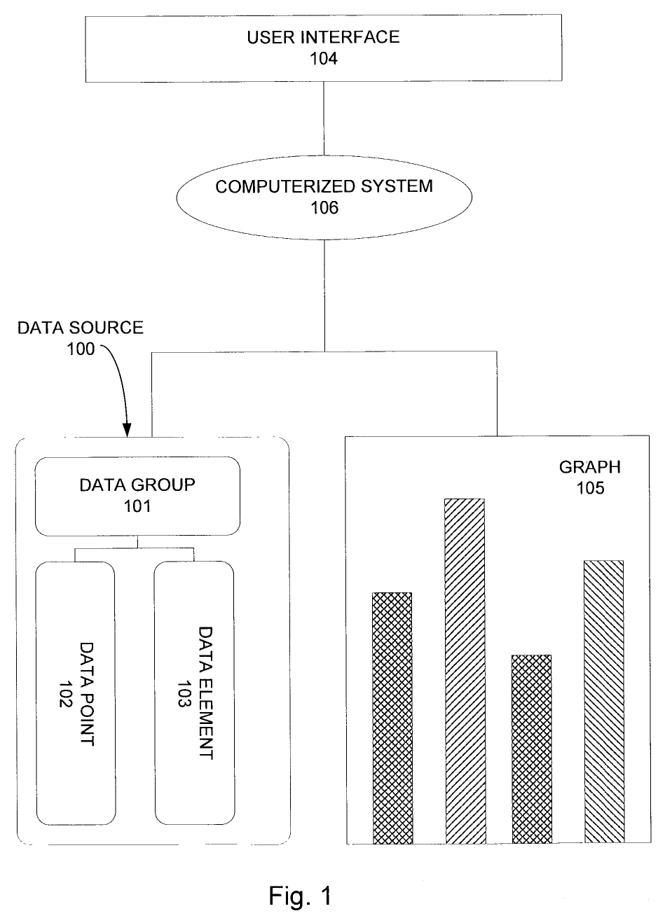

Referring now to FIG. 1, a block diagram representative of the present invention is illustrated. A user interface 104 is dynamically created by a computer system 106 according to a data source 100. The user interface can indicate a data source 100 as well as one or more structured subsets 101-103 of the data source 100. A subset can include one or more data groups or types 101, data points 102 and data elements 103. The user interface 104 is generated with user interactive portions which allow the user to select data to be displayed in a graphical representation 105. The interface 104 presents the data source 100 and subsets 101-103 in an interactive fashion that alleviates the need for a user to be familiar with an underlying data structure, or a protocol, such as ODBC.

A data group 101 can include a selection of data which is utilized to define a graph. A data group 101 can include datum grouped together because of a commonality. For example, a data group 101 containing data relating to a call center can include datum representing statistics associated with a call type, e-mail, agents or other related data. Fields of data associated with a data group 101 can come into view when a data group 101 is selected. The fields of data associated with the data group 101 can include data and statistics calculated from the data. As such, the fields can be organized so that the user can further indicate a data point 102 which is a subset of the data group 101 and have data elements 103 associated with the data point 102 displayed. An indication of which data elements 103 will be charted can then be made.

A data point 102 can refer to a field in the view which will be utilized to group query results by. For example, a data point 102 for data related to a call center that processes customer service calls can include: an agent name data field, a call type data field, a record time stamp data field, or other customer service type data field. Embodiments can include a default setting that allows data points 102 to be plotted on an X-axis of a graph generated. For example, there may be hundreds of data records related to a single agent name data field. Statistics relating to the data contained in the records related to a single agent name can be summarized into totals by grouping the results on agent name. Since each unique agent can be associated with a record, related data can be plotted as a data point 102 on the X-axis of the graph.

A data element 103 can include a statistic field in the view, wherein the field is summarized according to a selected data point 102. Numerical totals resulting from the summarization can be plotted on a Y-axis of a graph such that a data element represented once per data point 102 on a related graph.

The user interface 104 can also include a criteria item that can be selected in order to limit a query result to a particular set of desired values. A criteria item can include an item for which the value of one or more selected data elements 103 is displayed on a related chart. Accordingly, a criteria item will be based on a type of data group being used. For example, a data group based on an agent field can include a criteria item that is a combination of agent name, agent ID, department name, and site name.

A “saved graph” can indicate a graph that has been created and named and which can be loaded again at a future time. A saved graph can be created, for example by: copying a pre-defined graph, modifying and saving a pre-defined graph, creating a new graph or other method. Data which will be graphed, or otherwise displayed, can be accessed via an appropriate methodology, such as, for example: RDO, ODBC, DAO, and ADO.

Embodiments can include a list of pre-defined graphs which can be displayed on the interface 104, as well as a listing of saved graphs. A user can thereby load a pre-defined or saved graph and key in any necessary parameters in order to view, print or otherwise chart associated graph results. In addition, embodiments include enabling a user to modify properties of a charted graph, such as, for example, a display type, colors utilized, appearance, including whether the graph is three dimensional or flat, and other attributes.

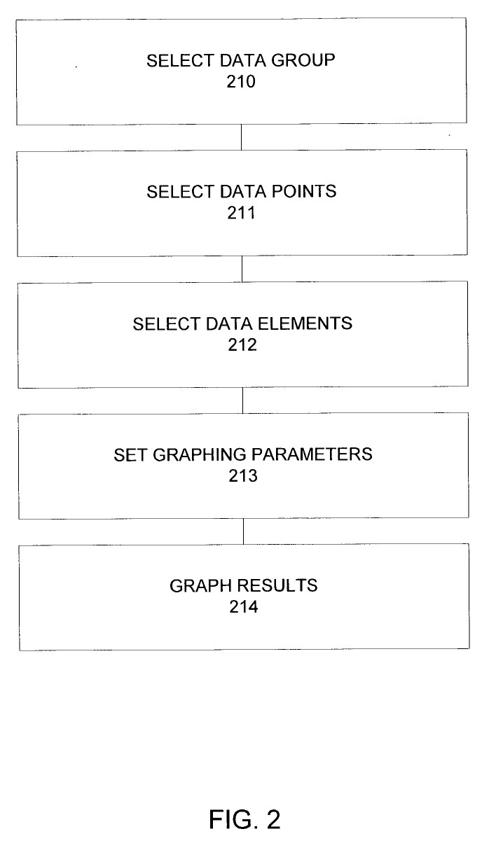

Referring now to FIG. 2, steps that a user can perform while implementing the present invention are illustrated. Embodiments can include associating an access restriction level and a feature set with particular data. Access restrictions can be accomplished, for example with different permissions such that permissions can be utilized to grant access to different fields of data. A particular application can thereby limit what is presented with matches to a specified feature set and access level. Accordingly, a user can be presented with a list of available data groups 101 with a permission level that is equal to or lesser than a restriction level of a graphing application and at least one of the features being utilized by the application. A data group 101 can be selected 210 from a data group 101 list. Following the selection of the data group 101, data points 102 and data elements 103 associated with the selected data group 101 and with a permission level that is equal to, or less than, the permission level of an application being utilized can be retrieved from an associated data table and presented, such as, for example, in two different lists. Embodiments can include data points 102 and the data elements 103 being listed in various orders, such as alphabetical order, relevance order, according to user preference or other order.

Typically, a field in the data source 100, such as a master data table, can contain a display name which can be utilized in various lists presented in the user interface 104. A display name can be meaningful to the user and descriptive of the data contained in the associated data field, or arbitrary, depending upon a particular application.

A user can select a data point 102 from a list of data points 102 presented to the user 211 and associated with the selected data group 101. Similarly, the user can also select one or more data elements 103 from a list of data elements 103 presented to the user 212. Each data element 103 will be associated with the data point 102.

In another aspect, embodiments can include a predefined graph already linked to pertinent data. Accordingly, in these embodiments, an appropriate data group 101 and associated data point 102 and data elements 103 can be loaded and presented if a predefined graph is loaded. For example, a predefined graph related to call center data may graph monthly summaries of calls received by a particular bank of agents.

Other embodiments can include a predefined graph that allows some customization or user selection of associated data. For example, a predefined graph may be set up to display a monthly summary, but allow a particular agent to be selected.

Graphing parameters can also be set 213, which enables the user to specify filters that can be applied to selected data that is to be presented in a graph. For example, parameters can specify that the graph include data within a specified date or time range, from a specific location, or other parameter.

The user interface 104 can also include a button or other interactive device for causing a graph to be presented 214 containing the results from the specified data group 101, data point 102 and data elements 103.

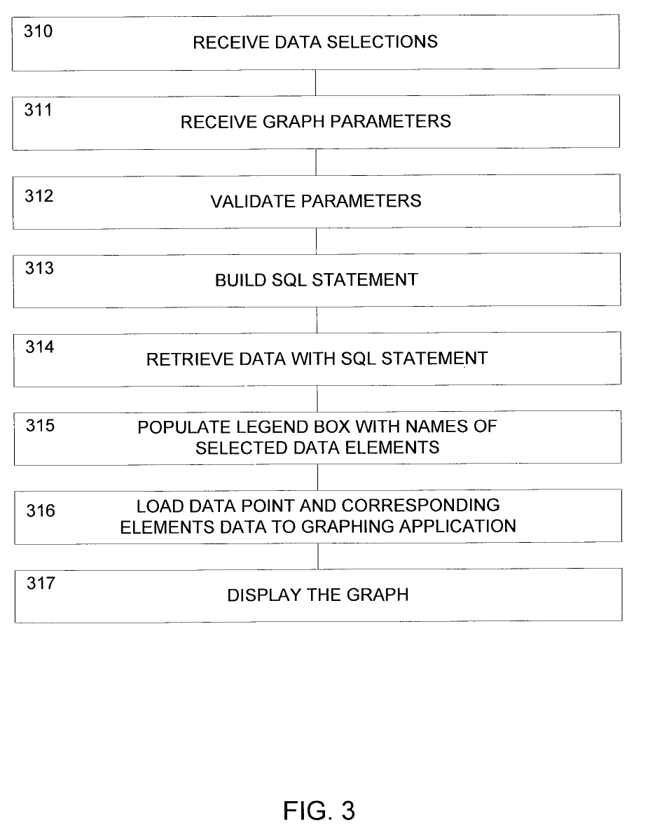

Referring now to FIG. 3, steps are illustrated which can be implemented to display a graph according to the present invention. A computerized system 106 can receive data selections 310, such as those made by a subscriber 111 via the user interface 104 and also receive graph parameters 311. Received parameters can be validated 312 and if any problems or inconsistencies are discovered the user can be notified and an appropriate screen presented to the user via which the user can correct the problem. Validation can include, for example, verifying that a date range input by a user falls within an acceptable range of dates according to the data source 100, or other validation technique applicable to manipulating data.

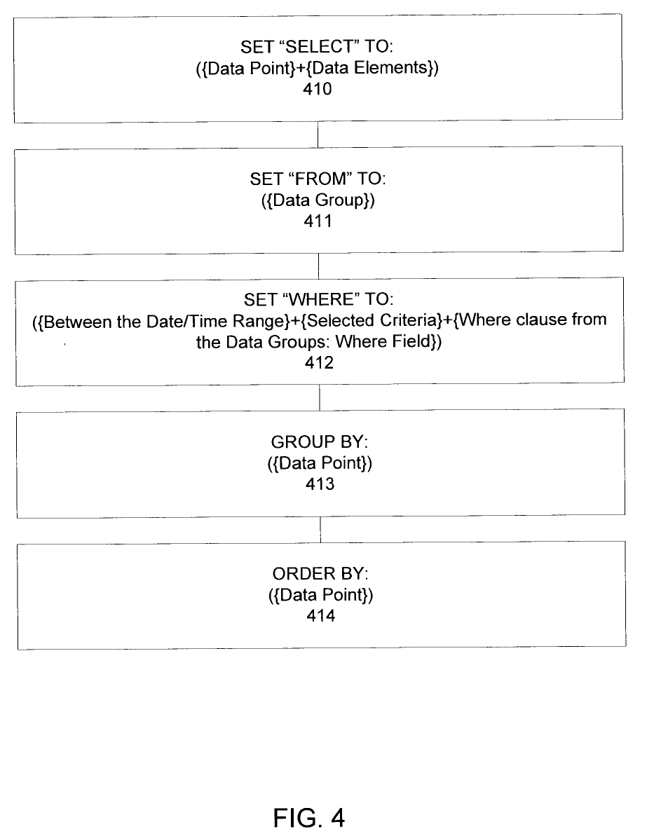

The computerized system 106 can build a SQL statement reflecting input relating to data selection and parameters 313. Further detail regarding how the SQL statement can be built is described below in reference to FIG. 4. The computerized system 106 can retrieve data from a specified data source 100 utilizing the SQL statement 314 and populate a legend box for a generated graph 315 with the names of selected data elements 103. The computerized system 106 can also load a designated data point 102 and corresponding data elements 103 into a graphing or charting application 316 and display a graph 317 or other representation of the selected data elements 103.

Referring now to FIG. 4, steps are illustrated which can be implemented by a computerized system 106 to build a SQL statement according to input received from the user interface 104. The SQL statement can be utilized to retrieve data from a data source 100.

A “Select” portion of a generated SQL statement can be set to:

({Data Point})+({Data Elements}) 410;

a “From” portion can be set to:

({Data Group}) 411; and

a “Where” portion can be set to:

({Between the Date/Time Range}+{Selected Criteria}+{Where clause from the Data Groups: Where Field}) 412.

The SQL statement can also reflect a “Group By” portion set to ({Data Point}) 413 and an “Order By” portion set to ({Data Point}) 414.

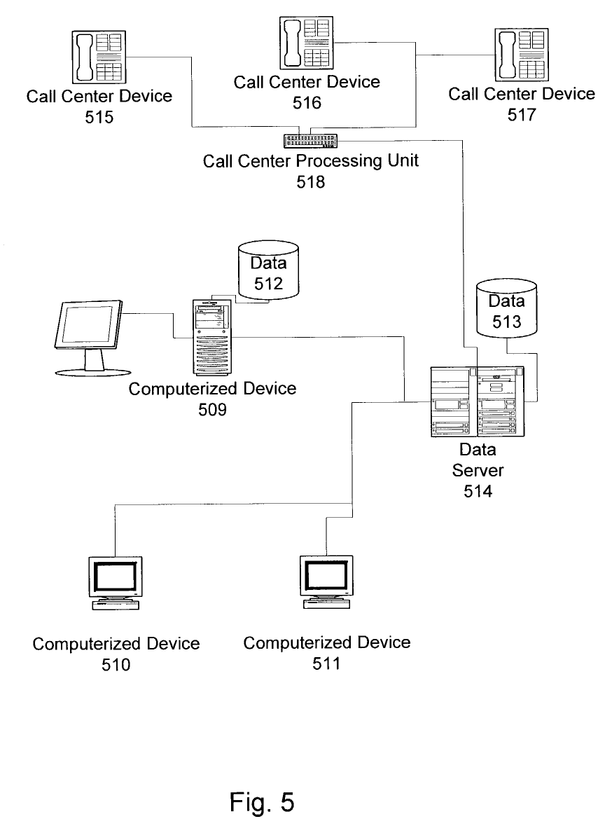

Referring now to FIG. 5, a diagram of computer related devices which can be utilized to implement the present invention are illustrated. A data source 100 which can include one or more data groups 101, data points 102, data elements 103 and other data can be stored in a data storage medium 512-513, such as a magnetic disk drive, or array of disk drives, such as a redundant array of independent disks (RAID). Access to the data storage medium 512-513 can be accomplished with any known technology, such as for example, via a data server 514 accessible via a communications network, such as a local area network, a wide area network, the Internet, or other network, or through direct linkage to a computerized device 509.

In some embodiments, a call center processing unit 518 can generate data 513 which is input into the data server 514. The call center unit 518 can gather input to generate the data 513 from one or more call center devices 515-517, such as a telephone bank, or other communication generation equipment.

A user can execute programmable software on a computerized device 509-511 in order to implement the steps of the present invention. Each computerized device may include a processor capable of operating the device, executing software or other tasks. For purposes of the present invention, a device may include one or more displays (e.g., screens, monitors, CRTs) and, in some embodiments, hardware and software needed to utilize the display, present text, graphics, etc. on the display, etc. Typically, a computerized device 509-511 will include a processor or controller capable of executing or implementing software and also may include: memory or data storage; input devices such as a keyboard and a mouse; output device, such as a printer, speaker, display and the like.

The methods of the present invention may be embodied as a computer program developed using a computer implemented software language including a range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, or any combination of the above. In addition, two or more of the steps in each of the methods described above can be performed on two or more different computers, computer systems, microprocessors, and the like, some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy disk or other magnetic or optical disk, magnetic or optical tape, CD-ROM, DVD, hard disk drive, flash or optical memory card, microprocessor, solid state memory device, random access memory (RAM), erasable programmable read only memory (EPROM), read only memory (ROM) or other storage vehicle.

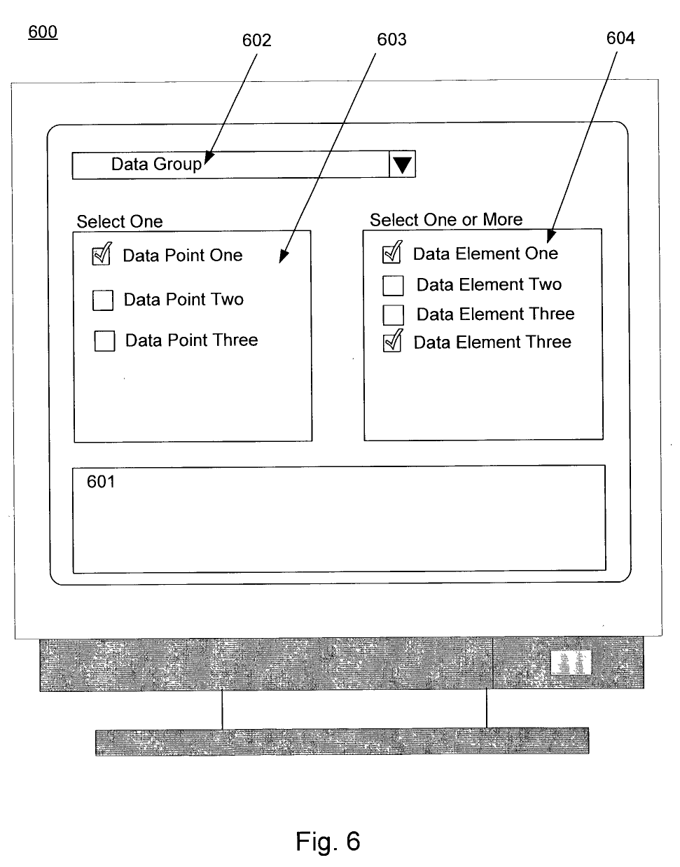

Referring now to FIG. 6, an exemplary graphical user interface (GUI) 600 that can be utilized to present elements of an interface 104 according to the present invention is illustrated. The GUI 600 can include an area on a display for presenting general instructions 601, as well as a user interactive area for indicating a data group 602. The user can indicate a data group, for example, by activating a drop down menu 602 and selecting an item from the displayed list with a pointing device or a keyboard. Other interactive areas can include an area for indicating a data point 603 and an area for indicating one or more data elements 604. The interactive areas for indicating one or more user preferences 602-604 can include a check box, Yes/No field or any other programmable user interactive device useful for interfacing with a user and allowing the user to indicate a one or more preferences.

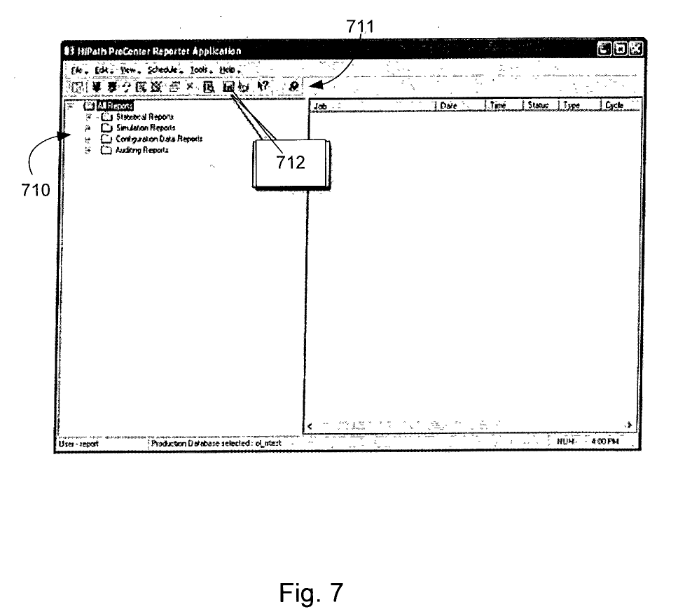

Referring now to FIG. 7, exemplary embodiments can include applications and charting directed towards call processing data such that a user that does not have technical expertise in SQL, or other database language or graphing, to readily graph statistical data from an ODBC compliant database. An exemplary GUI is shown which can be utilized in some embodiments. The GUI can include a user interactive device, such as a tool bar 711 button 712 which can be activated to present a graphical report options. Listed reports 710 can also be listed to facilitate easy access to a report by a user. The reports can include, for example, statistical reports, simulation reports, configuration reports, and auditing reports.

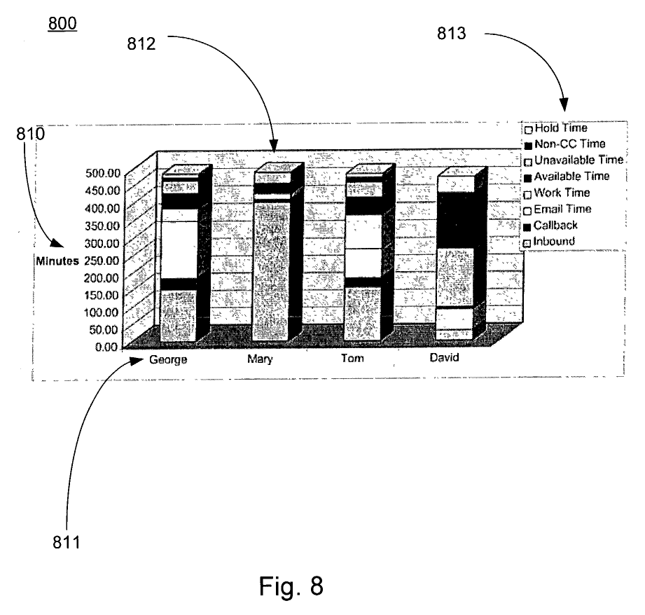

FIG. 8 illustrates an exemplary graph 800 that can be generated from data collected from a call center application, such as via a call center processing unit 518. The graph can include an operator 811 and a scale 810, or other indication, of an amount of time processing communications. For each operator 811, a graphical representation 812 can be generated and displayed 812 according to a key 813 of one or more tasks or other criteria. FIG. 8 illustrates a block type graph; however any graphical representation can also be within the scope of the invention.

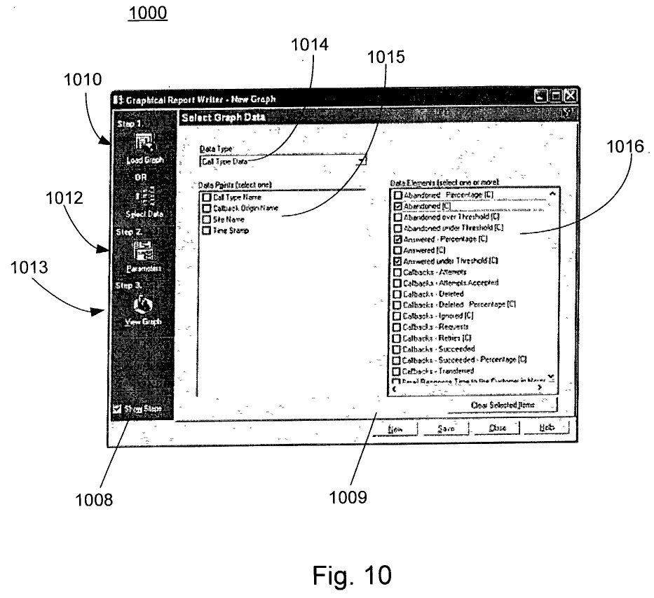

Referring now to FIG. 10, an exemplary GUI 1000 is illustrated with a display area representing steps 1010-1013 that a user can perform in order to generate and view a graph 1008, as well as a display area that can be utilized for selecting graph data 1009. A summary of steps illustrating the simplicity of actions required by a user in order to generate a graph can include loading a graph or selecting data 1010, selecting graph parameters 1012, and viewing a graph 1013.

Graph data can be selected according to Step 1 1010 with simple user interactive devices, such as, for example, drop down lists or check boxes, which do not require knowledge of underlying data structure, such as knowledge of a SQL data structure. A data type or data group 101 can be selected for example via a drop down list of available data groups 1014. FIG. 10 illustrates a Call Type Data, data group 101 selected from the drop down list 1014. A data point 102 can also be selected from the select data GUI 1009. As illustrated, the data point 102 is selected via a check box menu 1015. A check box menu 1016 can also be utilized, such as in the illustrated GUI 1000 for selecting one or more data elements 103.

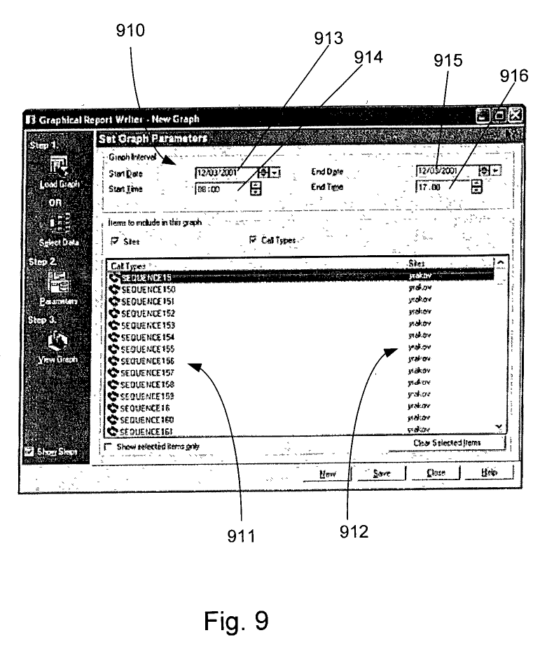

FIG. 9 illustrates an exemplary GUI 900 that can be utilized to facilitate selection of graph parameters 910, according to Step 2, 1012. Graph parameters 910 can include, for example, a start date 913, a start time 914 as well as an end date 915 and an end time 916. In addition, embodiments can allow selection of items to be included in a graph generated, such as, for example, one or more call types, illustrated as a list of sequences 911 and sites 912.

A graph 800 depicting the data selected, such as through the GUI's illustrated in FIG. 9 and FIG. 10, can be viewed according to Step 3, 1013.

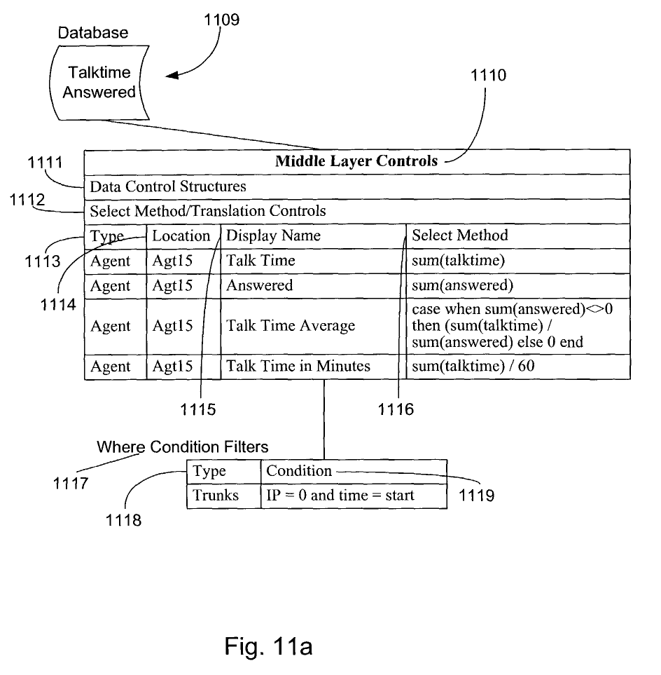

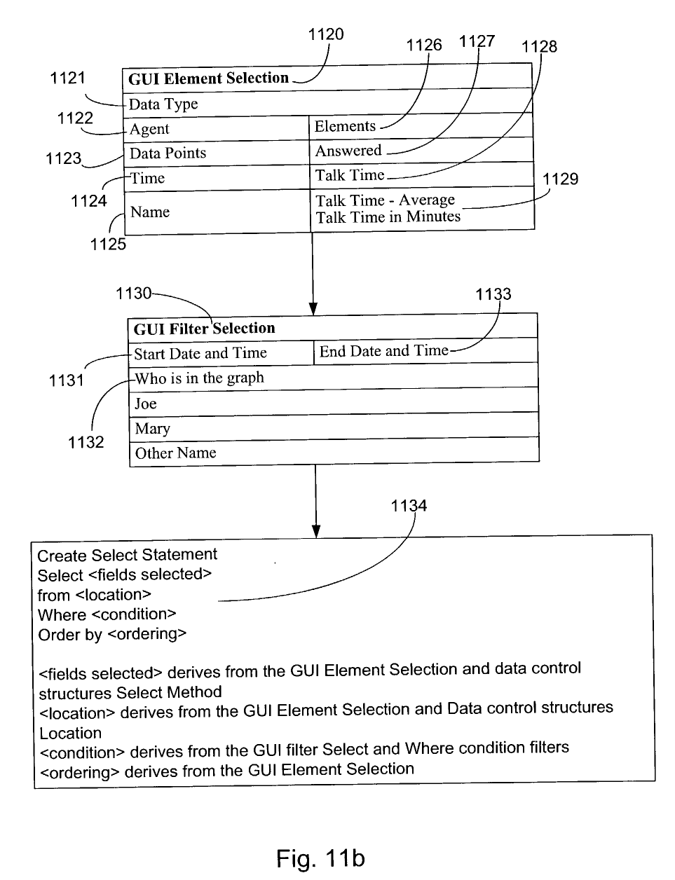

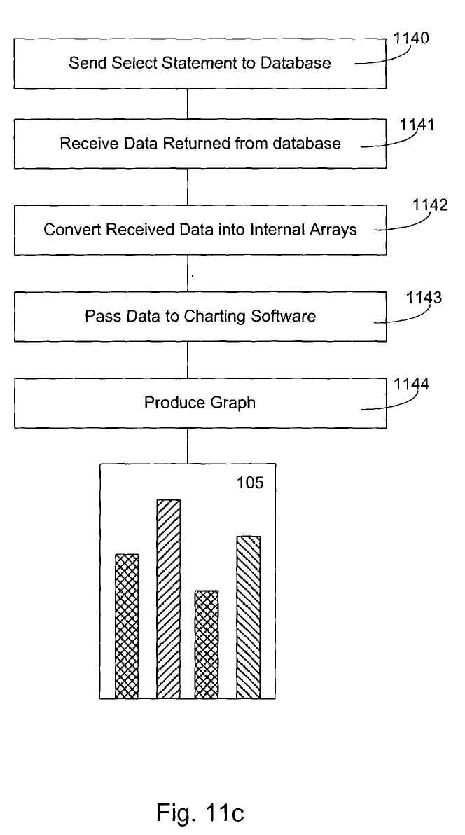

Referring now to FIGS. 11a-11c, a flow of exemplary steps that can be present in call center embodiments is illustrated. A database 1109 can be selected as a data source accessed by Middle Layer Controls 1110. The Middle Layer Controls 1110 can include data control structures 1111 and select method/translation controls 1112. In a particular embodiment illustrated, a type 1113 can be an agent and a location 1114 can include a description of an agent, such as Agtl5. A display name 1115 can include talk time, answered, talk time average, talk time in minutes, or other parameter. A select method 1116 can include: a sum(talktime); sum(answered); case when sum (answered)< >0 then (sum(talktime)/sum(answered) else 0 end; sum(talktime)/60; or other value.

The Middle Control Layers 1110 can be linked to one or more filters, such as where condition filters 1117, which can include a type 1118, such as trunks, and a condition 1119, such as IP=0 and time=start.

A GUI can be derived from or affected by the Middle Layer values, wherein a GUI element selection 1120 can include a data type 1121 with an agent 1122, data points 1123, time 1124, name 1125 or other data type. An element 1126 can include answered 1127, talk time 1128 and talk time—Average, talk time in Minutes 1129 or other value. The GUI filter selection 1130 can include a start date and time 1131 as well as an end date and time 1133, who is in the graph 1132, or other selection criteria.

A select statement can be created 1134 with the values input. For example, a “select” value can be determined from fields selected, a “from” value can be determined by a location value, a “where” value can be determined from a condition entered, and “order by” value can be determined by an ordering input. “Fields selected” can be derived from GUI element selection and data control structures location. “Location” can be derived from GUI element selection and data control structures location. “Condition” can be derived from GUI filter Select and Where condition filters. “Ordering” can be derived from GUI element selection.

The select statement can be sent to the database 1140 and data returned from the select statement can be received 1141. The received data can be converted into internal arrays 1142 and passed onto charting software 1143. A graph 105 can be produced 1144 according to the selections made.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

What is claimed is:

1. A method to facilitate viewing a quantitative relationship between two or more sets of values in graphical form, the method comprising:
receiving a description of a data source independent of a graphing application program;
generating a graphical user interface according to a database structure of the data source;
receiving input via the graphical user interface indicative of which data comprising the data source will be graphed;
dynamically generating one or more statements suitable for retrieving data from the data source, wherein the statement is responsive to the input received via the graphical user interface;
retrieving data from the data source via the one or more statements generated; and
graphing the retrieved data.

2. The method of claim 1, wherein the statement dynamically generated responsive to the input received via the graphical user interface comprises:
data fields;
a location of the data fields;
a condition filter for selecting data stored in the data fields; and
an order for data retrieved as a result of the database query.

3. The method of claim 1 wherein the statement dynamically generated responsive to the input received via the graphical user interface comprises a select statement.

4. The method of claim 1 wherein the input received via the graphical user interface comprises selection of: a data group, a data point and one or more data elements.

5. The method of claim 4 wherein the data group selected comprises a permission level which is equal to or less than a permission level of the graphing application program.

6. The method of claim 4 wherein each data point and data elements comprises a permission level which is equal to or less than a permission level of the graphing application program.

7. The method of claim 1 wherein the data source is an open database connectivity standard compliant database.

8. The method of claim 1 wherein the data source is a structure query language compliant database.

9. The method of claim 1 wherein the data source is a data access object compliant database.

10. The method of claim 1 wherein the data source is an ActiveX Data Objects compliant database.

11. The method of claim 1 wherein the data source is a Remote Data Objects compliant database.

12. The method of claim 1 additionally comprising the steps of:
receiving data returned from the data source as a result of the generated statement; and
converting the received data into internal arrays.

13. The method of claim 1 additionally comprising the step of loading a predefined graph comprising predefined selected data.

14. The method of claim 1 additionally comprising the step of loading a predefined graph comprising data interactively selected by a user.

15. The method of claim 1 additionally comprising the step of receiving one or more graph parameters.

16. A method for graphing data selected by a user, comprising:
determining an identity of said user;
selecting, based at least in part on said identity, a plurality of available data groups in an external database;
generating, based on said plurality of available data groups, a graphical user interface allowing said user to select: one of said plurality of available data groups, a data point in said selected data group, at least a first data element associated with said data point, and at least a first criteria item for graphing data; and
generating, based on said user selected data, a graphical depiction of said data.

17. The method of claim 16 wherein a data group comprises a selection of data which can be utilized to define a graph.

18. The method of claim 16 wherein a data point comprises a data field by which query results can be grouped.

19. The method of claim 16 wherein a data element comprises a statistic field in a view.

20. The method of claim 16 wherein a criteria item comprises an item utilized to limit a query result to a particular set of values.

21. A method for graphing data, comprising:
selecting a data group from among a plurality of available data groups;
selecting a data point in said selected data group;
selecting at least a first data element associated with said data point;
identifying at least a first criteria for graphing data;
retrieving, from an external database, data based on said at least first criteria, said at least first data element, said data point and said selected data group; and
generating a graphical depicting of said retrieved data.

22. The method of claim 21, wherein each of said available data groups is a set of data having a common characteristic.

23. The method of claim 21, wherein each of said available data groups is a set of call center data.

24. The method of claim 21, wherein said data point is a data field in said selected data group.

25. The method of claim 21, wherein said at least first data element is a statistic field summarized based on said data point.

26. The method of claim 21, wherein said at least first criteria is a value identifying particular characteristics of said at least first data element.

27. The method of claim 21, the method further comprising:
generating, based on said selected data group, a graphical user interface allowing user selection of said data point.

28. The method of claim 21, the method further comprising:
determining an identity of a user; and
generating, based at least in part on said identity of said user, a graphical user interface allowing said user to select among a plurality of data groups.

29. The method of claim 21, further comprising:
determining an identity of a user; and
identifying a plurality of data groups available to said user, said determining and identifying performed prior to said selecting said data group.

30. A system to facilitate viewing a quantitative relationship between two or more sets of values in graphical form, the system comprising:
a computerized device comprising a processor and a data storage medium capable of storing software and data; and
executable software stored on the computerized device and executable on demand, the software operative with the computerized device to cause the system to:
receive a description of a data source independent of a graphing application program;
generate a graphical user interface according to a database structure of the data source;
receive input via the graphical user interface indicative of which data comprising the data source will be graphed;
dynamically generate one or more statements suitable for retrieving data from the data source, wherein the statement is responsive to the input received via the graphical user interface;
retrieve data from the data source via the one or more statements generated; and
graphing the retrieved data.

31. The system of claim 30 wherein the statement dynamically generated responsive to the input received via the graphical user interface comprises:
data fields;
a location of the data fields;
a condition filter for selecting data stored in the data fields; and
an order for data retrieved as a result of the database query.

32. The system of claim 30 wherein the statement dynamically generated responsive to the input received via the graphical user interface comprises a select statement.

33. A system for graphing data selected by a user, the system comprising:
a computerized device comprising a processor and a data storage medium capable of storing software and data; and
executable software stored on the computerized device and executable on demand, the software operative with the computerized device to cause the system to:
determine an identity of said user;
select, based at least in part on said identity, a plurality of available data groups in an external database;
generate, based on said plurality of available data groups, a graphical user interface allowing said user to select: one of said plurality of available data groups, a data point in said selected data group, at least a first data element associated with said data point, and at least a first criteria item for graphing data; and
generate, based on said user selected data, a graphical depiction of said data.

34. A system for graphing data selected by a user, the system comprising:
a computerized device comprising a processor and a data storage medium capable of storing software and data; and
executable software stored on the computerized device and executable on demand, the software operative with the computerized device to cause the system to:
select a data group from among a plurality of available data groups;
select a data point in said selected data group;
select at least a first data element associated with said data point;
identify at least a first criteria for graphing data;
retrieve, from an external database, data based on said at least first criteria, said at least first data element, said data point and said selected data group; and
generate a graphical depicting of said retrieved data.

35. The system of claim 34, wherein each of said available data groups is a set of data having a common characteristic.

36. The system of claim 34, wherein each of said available data groups is a set of call center data.

37. The system of claim 34, wherein said data point is a data field in said selected data group.

38. The system of claim 34, wherein said at least first data element is a statistic field summarized based on said data point.

39. The system of claim 34, wherein said at least first criteria is a value identifying particular characteristics of said at least first data element.
